(19) United States
(12) Patent Application Publication
(10) Pub. No.: US 2026/0082114 A1
(43) Pub. Date: Mar. 19, 2026

(54) MOLDED BASE, CAMERA MODULE AND ELECTRONIC DEVICE

(71) Applicant: NINGBO SUNNY OPOTECH CO., LTD., Zhejiang (CN)

(72) Inventors: Linmin YE, Zhejiang (CN); Yidong Zhang, Zhejiang (CN); Peng Lu, Zhejiang (CN); Haifeng Yu, Zhejiang (CN); Dongju Wang, Zhejiang (CN); Fengliang Yi, Zhejiang (CN); Ji Bao, Zhejiang (CN); Qingjie Wang, Zhejiang (CN)

(73) Assignee: NINGBO SUNNY OPOTECH CO., LTD., Zhejiang (CN)

(21) Appl. No.: 19/327,309

(22) Filed: Sep. 12, 2025

(30) Foreign Application Priority Data
Sep. 13, 2024 (CN) 202411284015.5

(51) Int. Cl. H04N 23/51; G02B 7/00; G02B 7/02; H04N 23/54; H04N 23/57

(52) U.S. Cl. CPC H04N 23/51; G02B 7/006; G02B 7/025; H04N 23/54; H04N 23/57

(57) ABSTRACT

This application relates to a molded base, a camera module and electronic device. The molded base comprises: a first mounting portion having a lens mounting surface, wherein the first mounting portion comprises a first portion and a second portion; a second mounting portion having a first side wall and a second side wall which are opposite to each other in the first direction, wherein the first portion and the first side wall are spaced in the first direction, the second portion and the second side wall are spaced in the first direction, and the second mounting portion further has a chip mounting surface located between the first side wall and the second side wall; a first connecting portion which is connected to the first portion of the first mounting portion and the first side wall of the second mounting portion; and a second connecting portion which is connected to the second portion of the first mounting portion and the second side wall of the second mounting portion, and the sectional area of the first connecting portion being perpendicular to the first direction is larger than the sectional area of the second connecting portion being perpendicular to the first direction. The molded base according to the application may facilitate the molding liquid to rapidly flow to the area where the second mounting portion is located in the mold, thereby increasing the molding yield of the molded base.

### TECHNICAL FIELD

The present application relates to the field of imaging devices, and in particular to a molded base, a camera module and an electronic device.

### BACKGROUND ART

A camera module is provided with a photosensitive chip and a lens module. Usually, the photosensitive chip is mounted on a circuit board, and the lens module is mounted on a lens holder or a molded base. Since components such as circuit board, lens holder, and molded base have processing tolerances, and the photosensitive chip and circuit board, the lens module and lens holder or molded base are bonded with adhesive glue, and the filling amount of the adhesive glue also has tolerance, after the tolerances are accumulated, the lens module and the photosensitive chip are prone to tilt, thereby affecting the imaging quality.

In order to improve the assembly accuracy of the camera module, the photosensitive chip and the lens module can be arranged on the same base. Particularly, the base is formed by molding to be lower cost. However, the molded base is prone to have problems such as poor exhaust during injection molding, resulting in poor molding of the molded base and affecting production efficiency.

### SUMMARY

Based on the above problems, the present application provides a molded base, a camera module and an electronic device, which can not only reduce the assembly tilt of the camera module, but also facilitate molding of the molded base.

In a first aspect, the present application provides a molded base, which comprises:
a first mounting portion having a lens mounting surface, wherein the first mounting portion comprises a first portion and a second portion;
a second mounting portion having a first side wall and a second side wall which are opposite to each other in the first direction, wherein the first portion of the first mounting portion and the first side wall of the second mounting portion are spaced in the first direction, the second portion of the first mounting portion and the second side wall of the second mounting portion are spaced in the first direction, and the second mounting portion further has a chip mounting surface located between the first side wall and the second side wall;
a first connecting portion which is connected between the first portion of the first mounting portion and the first side wall of the second mounting portion; and
a second connecting portion which is connected between the second portion of the first mounting portion and the second side wall of the second mounting portion, wherein the sectional area of the first connecting portion being perpendicular to the first direction is larger than the sectional area of the second connecting portion being perpendicular to the first direction.

According to some examples of the present application, the first mounting portion comprises:
a mounting portion body having an inner side wall adjacent to the second mounting portion and an outer side wall away from the second mounting portion;
a lug arranged on the outer side wall of the mounting portion body, wherein the lens mounting surface is located on the lug.

According to some examples of the present application, the top surface of the lug is lower than the top surface of the mounting portion body.

According to some examples of the present application, the mounting portion body is in a frame shape surrounding the second mounting portion, and the mounting portion body has at least three corners, wherein the at least three corners are provided with the lugs.

According to some examples of the present application, the chip mounting surface is substantially rectangular, and the first direction is a width direction of the chip mounting surface.

According to some examples of the present application, the sectional area of the first connecting portion is gradually decreased from the first mounting portion to the second mounting portion.

According to some examples of the present application, the first direction is parallel to the chip mounting surface, and a direction perpendicular to the first direction and parallel to the chip mounting surface is a second direction, and a direction orthogonal to the first direction and the second direction is a third direction, and in the second direction, the width of the first connecting portion is greater than the width of the second connecting portion, and/or in the third direction, the thickness of the first connecting portion is greater than the thickness of the second connecting portion.

In a second aspect, the present application provides a camera module, which comprises:
a circuit board;
the molded base as described above, which is arranged on the circuit board;
a photosensitive chip, which is arranged on the chip mounting surface of the second mounting portion;
a lens module, which is arranged on the lens mounting surface of the first mounting portion and is located in the photosensitive path of the photosensitive chip.

According to some examples of the present application, a groove is provided on the bottom surface of the lens module, and the lug of the first mounting portion is inserted into the groove.

According to some examples of the present application, a first gap is formed between the bottom of the groove and the lens mounting surface, and a second gap is formed between the wall of the groove and the lug, the gap value of the first gap is smaller than the gap value of the second gap, and the first gap and the second gap are both filled with adhesive glue.

According to some examples of the present application, a third gap is formed between the bottom surface of the lens module and the circuit board, a gap value of the third gap is greater than the gap value of the first gap, and the third gap is filled with adhesive glue.

According to some examples of the present application, the gap value of the third gap is smaller than the gap value of the second gap.

According to some examples of the present application, a filter mounting surface is provided on the top of the first mounting portion, and a filter is provided on the filter mounting surface, and the filter is located between the lens module and the photosensitive chip in the optical path.

According to some examples of the present application, a glue overflow groove is provided on the top of the first mounting portion, and the glue overflow groove is connected to the outer edge of the filter mounting surface.

According to some examples of the present application, a filter seat is provided on the top of the first mounting portion, and the filter is mounted on the filter seat.

According to some examples of the present application, the filter seat is molded on the molded base, and the filter seat covers a part of the photosensitive chip.

In a third aspect, the present application provides an electronic device, which comprises:
an electronic device body;
the camera module as described above, which is arranged on the electronic device body.

In the molded base of the present application, the first connecting portion and the second connecting portion have differential designs, and the sectional area of the first connecting portion perpendicular to the first direction is larger than the sectional area of the second connecting portion perpendicular to the first direction. When the molded base is molded and the molding liquid enters the mold from the adjacent first portion, the molding liquid can form a flow path of the first connecting portion to the second mounting portion to the second connecting portion inside the mold, which facilitates the molding liquid to flow quickly to the area where the second mounting portion is located in the mold, avoiding the molding liquid from being difficult to fill the area where the second mounting portion is located due to excessive flow resistance, thereby improving the molding yield of the molded base.

### BRIEF DESCRIPTION OF THE DRAWINGS

In order to more clearly illustrate the technical solutions of the present application, the drawings required for use in the description of the examples will be briefly introduced below. Obviously, the drawings described below are only some examples of the present application. For those skilled in the art, other drawings can be obtained based on these drawings without exceeding the protection scope claimed by the present application.

FIG. 1 is a sectional view of a camera module according to an exemplary example of the present application;

FIG. 2 is a schematic diagram showing a molded base according to an exemplary example of the present application;

FIG. 3 is a schematic diagram showing a motor being arranged on a molded base according to an exemplary example of the present application;

FIG. 4 is a schematic diagram showing a photosensitive chip being arranged on a chip mounting surface according to an exemplary example of the present application;

FIG. 5 is a schematic diagram showing a flow path of a molding liquid according to an exemplary example of the present application;

FIG. 6 is a schematic diagram showing a shoulder height of a camera module according to an exemplary example of the present application;

FIG. 7 is a schematic diagram showing a first connecting portion according to an exemplary example of the present application;

FIG. 8 is a schematic diagram of a camera module according to an exemplary example of the present application;

FIG. 9 is a schematic diagram showing a motor being bonded to a molded base according to an exemplary example of the present application;

FIG. 10 shows an enlarged view of part A according to an exemplary example of the present application;

FIG. 11 is a schematic diagram showing an optical filter being arranged on a molded base according to an exemplary example of the present application;

FIG. 12 is a schematic diagram showing a filter seat being arranged on a molded base according to an exemplary example of the present application;

FIG. 13 is a schematic diagram of a filter seat according to an exemplary example of the present application;

FIG. 14 is a schematic diagram showing a molded base being molded on a circuit board according to an exemplary example of the present application;

FIG. 15 is a schematic diagram showing a filter seat being molded on a molded base according to an exemplary example of the present application;

FIG. 16 shows a sectional view of a circuit board, a molded base, and a filter seat according to an exemplary example of the present application;

FIG. 17 is a schematic diagram showing a molded base according to an exemplary example of the present application;

FIGS. 18A and 18B are schematic diagrams of electronic devices according to exemplary examples of the present application.

Particularly, in the figures:
100—camera module;
10—molded base; 20—circuit board; 30—photosensitive chip; 40—lens module; 50—filter; 60—filter seat; 70—steel plate;
1—first mounting portion; 11—mounting portion body; 12—lug; 13—lens mounting surface; 14—accommodating cavity; 15—filter mounting surface; 16—glue overflow groove; first portion 1a; and second portion 1b;
2—second mounting portion; 21—chip mounting surface; first side wall 2a; and second side wall 2b;
3—first connecting portion; 3a—one end of the first connecting portion; 3b—the other end of the first connecting portion;
4—second connecting portion;
410—motor; 420—groove;
61—first light-through hole; 62—filter mounting slot; and 63—second light-through hole.

### DETAILED DESCRIPTION

Exemplary examples will now be described more fully with reference to the accompanying drawings. However, exemplary examples can be implemented in many forms and should not be construed as limited to the examples set forth herein; rather, these examples are provided so that this application will be thorough and complete, and will fully convey the concept of the exemplary examples to those skilled in the art. The same reference numerals in the drawings denote the same or similar parts, and thus their repeated description will be omitted.

The described features, structures, or characteristics may be combined in any suitable manner in one or more examples. In the following description, numerous specific details are provided to give a thorough understanding of examples of the present disclosure. However, those skilled in the art will appreciate that the technical solutions of the present disclosure may be practiced without one or more of these specific details, or may adopt other modes, components, materials, devices, etc. In these instances, well-known structures, methods, apparatuses, implementations, materials, or operations are not shown or described in detail.

The terms “first”, “second” and the like in the specification and claims of this application and the above drawings are used to distinguish different objects rather than to describe a specific order. In addition, the terms “comprise/include,” “comprising/including,” and “has,” and any variations thereof, are intended to cover a non-exclusive inclusion. For example, a process, method, system, product or apparatus comprising a series of steps or units is not limited to the listed steps or units, but may optionally comprise unlisted steps or units, or may optionally comprise other steps or units inherent to the process, method, product or apparatus.

The technical solutions of the present application will be described in detail below with reference to the accompanying drawings.

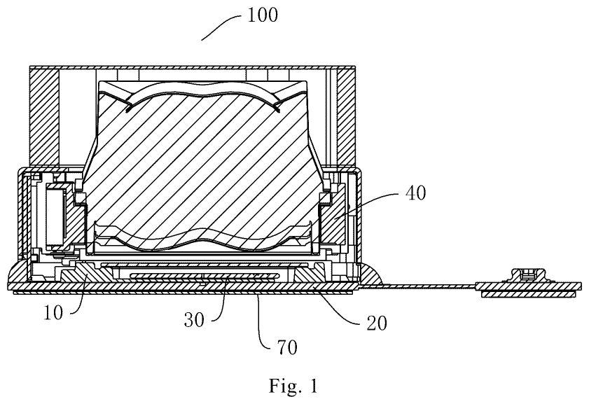

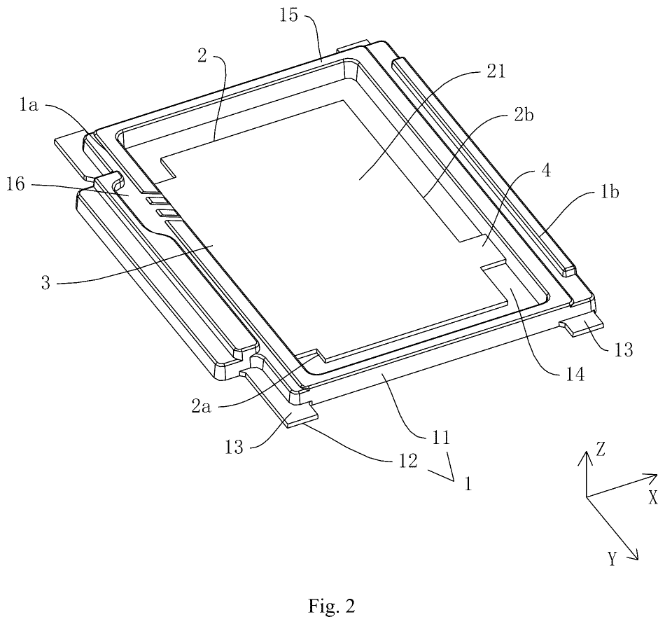

FIG. 1 shows a sectional view of a camera module according to an exemplary example of the present application, and FIG. 2 shows a schematic diagram of a molded base according to an exemplary example of the present application. As shown in FIGS. 1-2, an example of the present application provides a molded base 10, which is molded on a circuit board 20. The photosensitive chip 30 and the lens module 40 are both mounted on the molded base 10. The molded base 10 comprises a first mounting portion 1, a second mounting portion 2, a first connecting portion 3 and a second connecting portion 4.

FIG. 3 is a schematic diagram showing a motor being arranged on a molded base according to an exemplary example of the present application. As shown in FIGS. 2-3, the first mounting portion 1 has a lens mounting surface 13, which is used to mount the lens module 40. The lens mounting surface 13 is perpendicular to the optical axis of the lens module 40. For example, the lens module 40 comprises a motor 410 which is located at the bottom of the lens module 40, and the motor 410 is mounted on the first mounting portion 1.

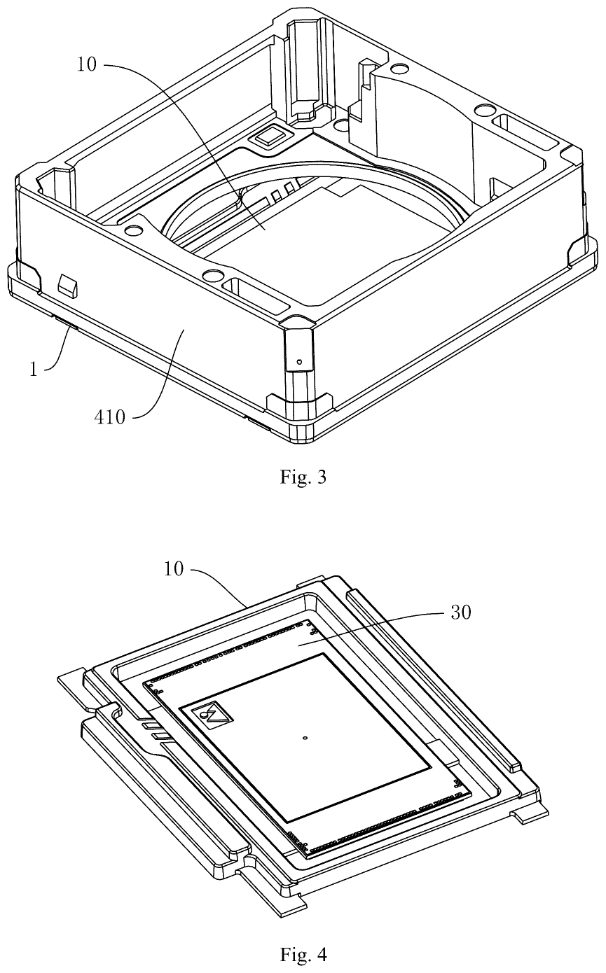

FIG. 4 is a schematic diagram showing a photosensitive chip being arranged on a chip mounting surface according to an exemplary example of the present application. As shown in FIG. 4, the top surface of the second mounting portion 2 is a chip mounting surface 21, which is used to mount the photosensitive chip 30. The chip mounting surface 21 is substantially parallel to the lens mounting surface 13. The chip mounting surface 21 is rectangular, which matches the shape of a conventional photosensitive chip.

By molding the lens mounting surface 13 and the chip mounting surface 21 on the molded base 10, the tolerance accumulation of the lens mounting surface 13 and the chip mounting surface 21 located in different components can be reduced, thereby making the lens module 40 and the photosensitive chip 30 less likely to be tilted when they are assembled. Furthermore, as compared with simultaneously molding the lens mounting surface 13 and the chip mounting surface 21 using metal such as stainless steel, in order to achieve a high degree of flatness on the stainless steel plate, high-cost processes such as acid corrosion and etching are required, the molded base 10 in this application has a lower processing cost.

Optionally, with the chip mounting surface 21 as a reference surface, the parallelism of the lens mounting surface 13 is 10-20 μm, so that the chip mounting surface 21 and the lens mounting surface 13 remain substantially parallel. The higher the parallelism between the chip mounting surface 21 and the lens mounting surface 13, the better the optical axis of the lens module 40 can be perpendicular to the photosensitive surface of the photosensitive chip 30.

For ease of description, the width direction of the chip mounting surface 21 is referred to as a first direction, i.e., the X direction in FIG. 2; the length direction of the chip mounting surface 21 is referred to as a second direction, i.e., the Y direction in FIG. 2; and the height direction of the molded base 10 is referred to as a third direction, i.e., the Z direction in FIG. 2.

The first mounting portion 1 comprises a first portion 1a and a second portion 1b in the first direction. The second mounting portion 2 has a first side wall 2a and a second side wall 2b in the first direction, and the chip mounting surface 21 is between the first side wall 2a and the second side wall 2b of the second mounting portion 2. Particularly, the first portion 1a and the first side wall 2a of the second mounting portion 2 are spaced in the first direction, and the second portion 1b and the second side wall 2b of the second mounting portion 2 are spaced in the first direction.

A first connecting portion 3 is connected between the first portion 1a of the first mounting portion 1 and the first side wall 2a of the second mounting portion 2. A second connecting portion 4 is connected between the second portion 1b of the first mounting portion 1 and the second side wall 2b of the second mounting portion 2, so that the first portion 1a, the first connecting portion 3, the second mounting portion 2, the second connecting portion 4 and the second portion 1b are connected sequentially in the width direction of the chip mounting surface 21, thereby allowing the first connecting portion 3 and the second connecting portion 4 to extend in the length direction of the chip mounting surface 21, and allowing enough space to design the first connecting portion 3 and the second connecting portion 4, thereby improving the supporting performance of the molded base 10.

The sectional area of the first connecting portion 3 being perpendicular to the first direction is greater than the sectional area of the second connecting portion 4 being perpendicular to the first direction. In this example, there is no restriction on the sectional shape of the first connecting portion 3 perpendicular to the first direction and the sectional shape of the second connecting portion 4 perpendicular to the first direction, and they can be regular rectangles, circles, trapezoids, etc., or irregular shapes. However, for ease of processing, regular rectangles are usually preferred. In this example, there is no restriction on whether the sectional area of the first connecting portion 3 being perpendicular to the first direction and the sectional area of the second connecting portion 4 being perpendicular to the first direction are variable. If the extension shape of any one of the first connecting portion 3 and the second connecting portion 4 along the first direction is variable, such as gradually decreasing or gradually increasing along the first direction, it only needs to satisfy that the minimum area of the sectional area of the first connecting portion 3 being perpendicular to the first direction is greater than or equal to the maximum area of the sectional area of the second connecting portion 4 being perpendicular to the first direction.

Further, in the second direction, the width of the first connecting portion 3 is greater than the width of the second connecting portion 4, and/or in the third direction, the thickness of the first connecting portion 3 is greater than the thickness of the second connecting portion 4. For example, the first connecting portion 3 and the second connecting portion 4 have the same thickness, the length of the first connecting portion 3 along the first direction is the same as the length of the second connecting portion 4 along the first direction, and the width of the first connecting portion 3 along the second direction (Y direction) is 5-8 times the width of the second connecting portion 4 along the second direction.

In other examples, the first direction may be the length direction of the chip mounting surface 21, and the second direction may be the width direction of the chip mounting surface 21. In this way, the first portion 1a, the first connecting portion 3, the second mounting portion 2, the second connecting portion 4, and the second portion 1b are sequentially connected in the length direction of the chip mounting surface 21.

The first mounting portion 1, the second mounting portion 2, the first connecting portion 3 and the second connecting portion 4 are integrally formed by molding, and the chip mounting surface 21 and the lens mounting surface 13 both have a high degree of flatness, which reduces the assembly tilt of the camera module caused by the processing errors of the chip mounting surface 21 and the lens mounting surface 13, thereby improving the overall assembly accuracy of the camera module.

The molded base 10 is molded on the circuit board 20 and has high structural strength and heat resistance, thereby effectively preventing the photosensitive chip 30 mounted on the chip mounting surface 21 from tilting or warping.

FIG. 5 is a schematic diagram showing a flow path of a molding liquid according to an exemplary example of the present application. As shown in FIG. 5, a liquid injection port of the mold is arranged on a side close to the first connecting portion 3, and the liquid injection port of the mold and the second connecting portion 4 are arranged substantially in a diagonal line. The flow path of the molding liquid is shown by the arrow in FIG. 5. During molding, the resistance of the molding liquid flowing to the first connecting portion 3 is less than the resistance of the molding liquid flowing to the second connecting portion 4, and a pressure difference can be formed on both sides of the center portion inside the mold. The molding liquid forms a flow path of the first connecting portion 3 to the second mounting portion 2 to the second connecting portion 4, which facilitates the molding liquid to flow quickly to the area where the second mounting portion 2 is located in the mold, thereby improving the molding yield of the molded base 10.

Optionally, the photosensitive chip 30 is arranged on the chip mounting surface 21 by adhesive glue. A gap is reserved between the first mounting portion 1 and the second mounting portion 2.

In some examples, the circuit board 20 and the photosensitive chip 30 are connected via lead wire, and the lead wire pass through the gap between the first mounting portion 1 and the second mounting portion 2. One end of the lead wire is connected to the circuit board 20, and the other end of the lead wire is connected to the photosensitive chip 30, so that the circuit board 20 and the photosensitive chip 30 are electrically connected. Optionally, the lead wire is located on a short side of the second mounting portion 2.

For example, the lead wire is a gold wire, and after the photosensitive chip 30 is bonded to the chip mounting surface 21 of the second mounting portion 2, the photosensitive chip 30 is electrically connected to the circuit board 20 through a gold wire mounting process. The lead wire may also be other types of lead wires, such as silver wire, copper wire, etc.

As shown in FIG. 2, in some examples, the first mounting portion 1 comprises: a mounting portion body 11 and a lug 12. The mounting portion body 11 is substantially in the shape of a nested square, and has an inner side wall adjacent to the second mounting portion 2 and an outer side wall away from the second mounting portion 2. The lug 12 is arranged on the outer side wall of the mounting portion body 11. Optionally, there are multiple lugs 12, for example, there are four lugs 12, and the four lugs 12 are respectively arranged at four corners of the mounting portion body 11, so that the distribution of the lugs 12 can be more balanced. In other examples, the number of the lugs 12 may also be three.

The bottom surface of the lug 12 is flush with the bottom surface of the mounting portion body 11. The size of the lug 12 is set according to needs. For example, the length of the lug 12 along the first direction is about ⅛ of the length of the mounting portion body 11 along the first direction, and the width of the lug 12 along the second direction is about 1/15 of the width of the mounting portion body 11 along the second direction. Optionally, at least a part of the lug 12 is L-shaped to improve the structural strength of the lug 12.

The lens mounting surface 13 is located on the lug 12, for example, the top surface of the lug 12 is used as the lens mounting surface 13. Setting the lens mounting surface 13 on the lug 12 instead of using the top surface of the mounting portion body 11 as the lens mounting surface can reduce the total area of the lens mounting surface 13 and the difficulty of processing high parallelism between the lens mounting surfaces 13, thereby reducing the tilt of lens assembly caused by processing errors and improving the assembly accuracy of the camera module.

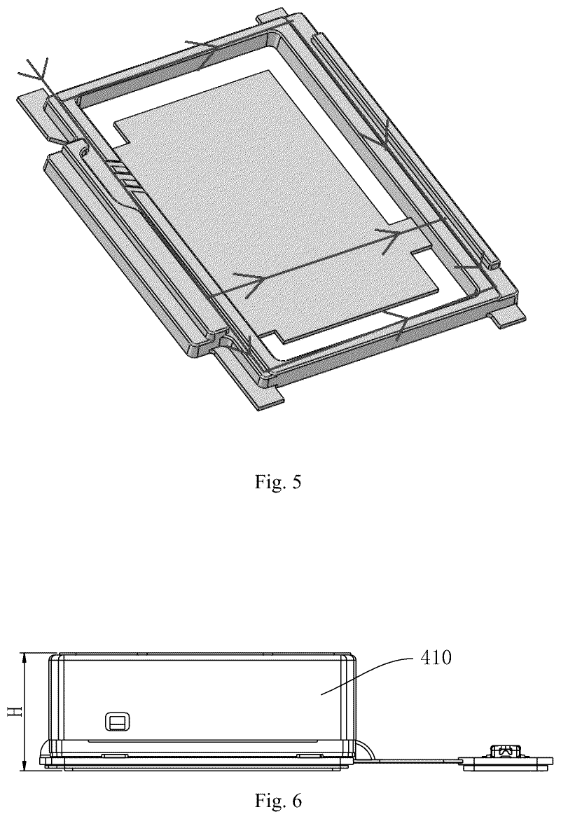

FIG. 6 is a schematic diagram showing a shoulder height of a camera module according to an exemplary example of the present application. In some examples, the top surface of the lug 12 is lower than the top surface of the mounting portion body 11. For example, the bottom surface of the lug 12 is flush with the bottom surface of the mounting portion body 11, and the thickness (height in the Z direction) of the lug 12 is ⅕ of the thickness of the mounting portion body 11. As shown in FIG. 6, the shoulder height H of the camera module is the height from the bottom surface of the camera module to a step surface of the motor 410. When the camera module is assembled to an electronic device, the shoulder height H of the camera module affects the thickness of the electronic device, the greater the shoulder height H of the camera module is, the greater the thickness of the electronic device is.

In the conventional camera module, the motor 410 is arranged on the filter holder or on the top surface of the molded base 10. In this example, the motor 410 is arranged on the lug 12, and the top surface of the lug 12 is lower than the top surface of the mounting portion body 11, so that the shoulder height H of the camera module can be reduced, thereby reducing the thickness of the electronic device.

In some examples, the mounting portion body 11 is in a frame shape surrounding the second mounting portion 2. For example, the mounting portion body 11 is substantially in the shape of nested squares. The mounting portion body 11 has at least three corners, wherein at least three corners are provide with the lugs 12.

In some examples, the interior of the first mounting portion 1 is a through accommodating cavity 14. The second mounting portion 2 is located in the accommodating cavity 14, thereby reducing the overall height of the molded base 10.

Optionally, the thickness of the second mounting portion 2 is smaller than the thickness of the mounting portion body 11, so that the photosensitive chip 30 can be arranged in the accommodating cavity 14.

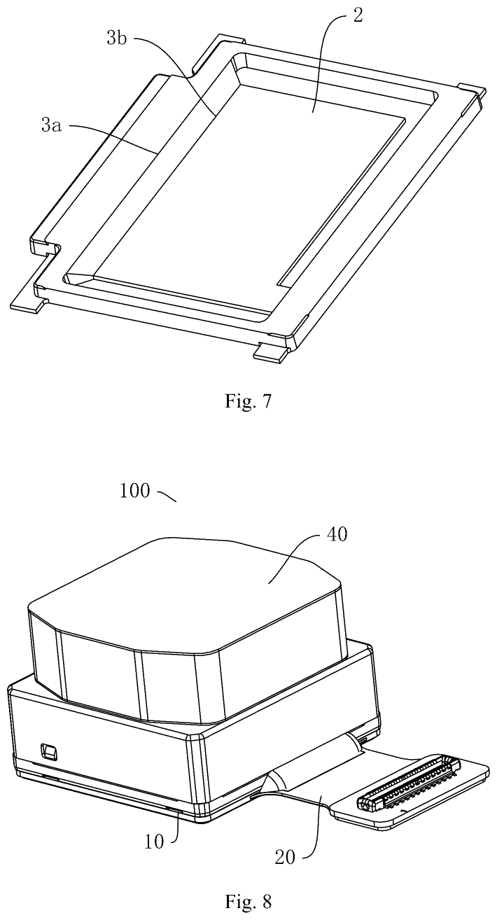

FIG. 7 is a schematic diagram showing a first connecting portion according to an exemplary example of the present application. As shown in FIG. 7, in some examples, the width direction of the chip mounting surface 21 is referred to as a first direction, and from the inner wall of the first mounting portion 1 to the first side wall 2a of the second mounting portion 2, the sectional area of the first connecting portion 3 being perpendicular to the first direction is gradually decreased. The area of the end surface of the first connecting portion 3 connected to the end 3a of the first mounting portion 1 is larger than the area of the end surface of the first connecting portion 3 connected to the end 3b of the second mounting portion 2. From the first mounting portion 1 to the second mounting portion 2, the size and thickness of the cross section of the first connecting portion 3 being perpendicular to the first direction are gradually reduced.

According to Bernoulli's principle, from the inner wall of the first mounting portion 1 to the first side wall 2a of the second mounting portion 2, the sectional area of the first connecting portion 3 being perpendicular to the first direction is gradually decreased, which accelerates the molding liquid to enter the area where the second mounting portion 2 is located from the area where the first connecting portion 3 is located in the mold, thereby improving the molding yield of the second mounting portion 2.

In some examples, as shown in FIG. 7, the end surface area of the end portion 3b of the first connecting portion 3 connected to the second mounting portion 2 is equal to the area of the side wall of the second mounting portion 2 connected to the first connecting portion 3.

In another example, the end surface area of the end portion 3b of the first connecting portion 3 connected to the second mounting portion 2 is smaller than the area of the side wall of the second mounting portion 2 connected to the first connecting portion 3, so as to reduce the material used for the first connecting portion 3. The size of the first connecting portion 3 is set according to the requirements. If the size of the first connecting portion 3 is too small, the flow of the molding liquid may be affected, thereby affecting the molding liquid from filling the area where the second mounting portion 2 is located in the mold.

FIG. 8 is a schematic diagram showing a camera module according to an exemplary example of the present application. As shown in FIG. 1 and FIG. 8, an example of the present application provides a camera module 100, which comprises: a molded base 10, a circuit board 20, a photosensitive chip 30, and a lens module 40 as described above.

The molded base 10 is integrally formed on the circuit board 20 through a molding process. The molded base 10 has a lens mounting surface 13 and a chip mounting surface 21. The photosensitive chip 30 is arranged on the chip mounting surface 21 of the second mounting portion 2. The lens module 40 is arranged on the lens mounting surface 13 of the first mounting portion 1. The lens module 40 is located on the photosensitive path of the photosensitive chip 30.

For example, the photosensitive chip 30 is arranged on the chip mounting surface 21 by adhesive glue. During the process of mounting the photosensitive chip 30 on the chip mounting surface 21, the adhesive glue is coated on the chip mounting surface 21 of the second mounting portion 2. The adhesive glue can be adhesive materials such as glue and solid glue. The photosensitive chip 30 is arranged on the chip mounting surface 21, and the adhesive glue is cured so that the photosensitive chip 30 is bonded to the chip mounting surface 21.

The lens module 40 is mounted on the lens mounting surface 13 by adhesive glue. The bonding process of the lens module 40 is the same as the bonding process of the photosensitive chip 30, and will not be described in detail. When the first mounting portion 1 is provided with a lug 12, the lens mounting surface 13 is located on the top surface of the lug 12. Optionally, the lens module 40 is bonded to the lug 12 and the circuit board 20, respectively.

In other examples of the camera module, the number of the lens modules 40 may be more than one, and accordingly, the number of the photosensitive chips 30 may be more than one to form an array camera module. In addition, the type of the lens module 40 can be adjusted accordingly according to the requirements of the camera module. For example, the lens module 40 can be implemented as an integrated optical lens, a split optical lens, a bare lens, or an optical lens comprising a lens barrel, etc. This application does not impose any restrictions on this.

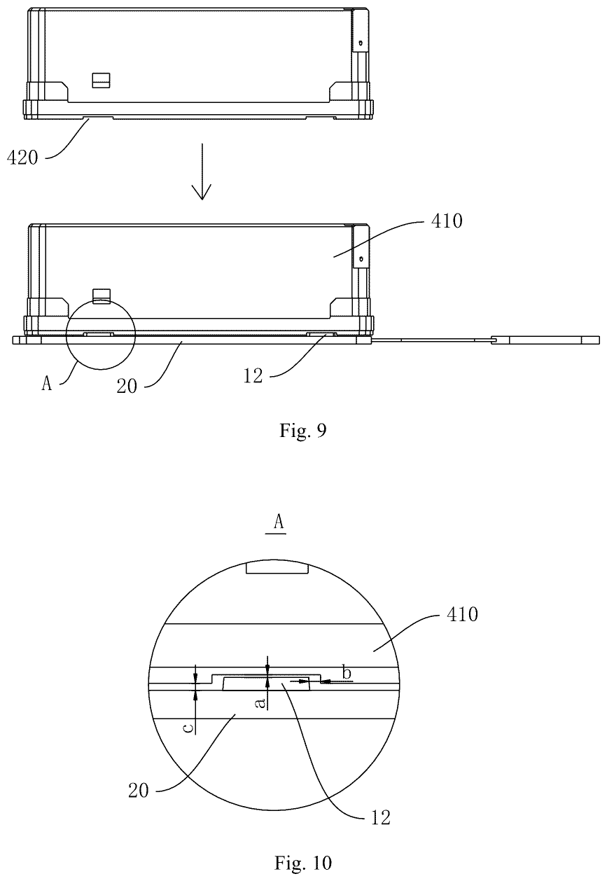

FIG. 9 is a schematic diagram showing a motor being bonded to a molded base according to an exemplary example of the present application. As shown in FIG. 9, in some examples, a groove 420 is provided on the bottom surface of the lens module 40, for example, a groove 420 is provided on the bottom surface of the motor 410. The groove 420 corresponds to the lug 12 of the first mounting portion 1, and the lug 12 can be inserted into the groove 420 to mount the lens module 40 to the first mounting portion 1.

Adhesive glue is filled between the groove 420 and the lug 12. When the groove 420 is not provided, the lens module 40 is only bonded to the lens mounting surface 13, and the adhesion surface of the adhesive glue is relatively small. A groove 420 is provided on the bottom surface of the lens module 40, and adhesive glue is filled between the side wall of the groove 420 and the side wall of the lug 12 and between the groove bottom of the groove 420 and the lens mounting surface 13, so as to increase the adhesion surface of the adhesive glue and thus increase the bonding strength. As required, adhesive glue may also be provided between the lens module 40 and the circuit board 20.

FIG. 10 is an enlarged view of part A of an exemplary example of the present application. As shown in FIG. 10, in some examples, a first gap a is formed between the bottom of the groove 420 and the lens mounting surface 13, and a second gap b is formed between the groove wall of the groove 420 and the lug 12. The first gap a and the second gap b are both filled with adhesive glue. The gap value of the first gap a is the height of the first gap a along the Z direction. The gap value of the second gap b is the length of the second gap b along the Y direction. The gap value of the first gap a is smaller than the gap value of the second gap b, so that the amount of adhesive glue filled in the second gap b is greater than the amount of adhesive glue filled in the first gap a. The adhesive glue will shrink unevenly during the curing process, which may easily lead to an uneven surface of the adhesive glue. The more adhesive glue there is, the greater the degree of shrinkage of the adhesive glue is, which may easily lead to tilting of the lens module 40 during assembly. By concentrating more adhesive glue in the second gap b, less adhesive glue is filled in the first gap a, thereby reducing the shrinkage of the adhesive glue filled in the first gap a, thereby improving the parallelism of the bottom of the groove 420 relative to the lens mounting surface 13 and reducing the possibility of tilting of the lens module 40 during assembly.

In some examples, a third gap c is formed between the bottom surface of the lens module 40 and the circuit board 20, for example, a third gap c is formed between the bottom surface of the motor 410 and the circuit board 20. The gap value of the third gap c is the height of the third gap c along the Z direction. The third gap c is filled with adhesive glue. The adhesive glue is provided between the lens module 40 and the circuit board 20 to better fix the lens module 40.

The gap value of the third gap c is greater than the gap value of the first gap a, which is conducive to more reliable bonding of the lens module 40 and the circuit board 20. If the gap value of the third gap c is too small, the bonding reliability between the lens module 40 and the circuit board 20 may be reduced.

In some examples, the gap value of the third gap c is smaller than the gap value of the second gap b. The gap value of the third gap c is between the gap value of the first gap a and the gap value of the second gap b, which is beneficial to reducing the tilt of the lens module 40 caused by assembly.

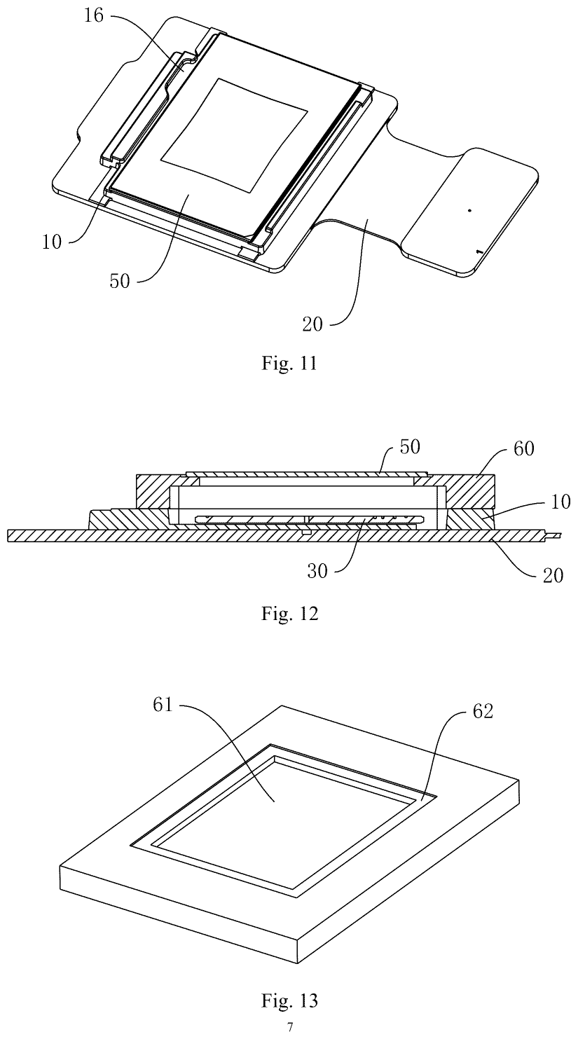

FIG. 11 is a schematic diagram showing an optical filter being arranged on a molded base according to an exemplary example of the present application. As shown in FIG. 11, in some examples, the camera module 100 further comprises a filter 50, which is arranged on the molded base 10. The filter 50 is located on the optical axis of the lens module 40 and is used to filter out stray light such as infrared rays to improve the image quality of the camera module. In the optical path, the filter 50 is located between the lens module 40 and the photosensitive chip 30.

As shown in FIG. 2, in some examples, a filter mounting surface 15 is provided on the top of the first mounting portion 1, and the filter mounting surface 15 is a flat surface. The filter 50 is arranged on the filter mounting surface 15. Optionally, the filter 50 is connected to the filter mounting surface 15 by adhesive glue.

At the time of assembling the filter 50, the adhesive glue is applied to the filter mounting surface 15, and then the filter 50 is mounted on the filter mounting surface 15. After the adhesive glue on the filter mounting surface 15 is cured, the filter 50 and the filter mounting surface 15 are bonded.

A glue overflow groove 16 is arranged on the top of the first mounting portion 1, and the glue overflow groove 16 corresponds to the filter 50. For example, the glue overflow groove 16 is connected to the outer edge of the filter mounting surface 15. At the time of installing the filter 50 on the filter mounting surface 15, the filter 50 is pressed appropriately so that the adhesive glue on the filter mounting surface 15 fully contacts the filter 50. At the time of pressing the filter 50, the excess adhesive glue squeezed out flows into the overflow groove 16, thereby preventing the adhesive glue from contaminating other components.

Optionally, the top surface of the second mounting portion 2 is lower than the top surface of the mounting portion body 11, so as to facilitate setting the filter 50 on the molded base 10 to avoid interference between the filter 50 and the photosensitive chip 30.

FIG. 12 is a schematic diagram showing an optical filter seat being arranged on a molded base according to an exemplary example of the present application, and FIG. 13 is a schematic diagram showing the optical filter seat according to an exemplary example of the present application. As shown in FIGS. 12-13, the camera module 100 further comprises a filter seat 60. The filter seat 60 is arranged on the top of the molded base 10. The top surface of the filter seat 60 is provided with a first light-through hole 61 and a filter mounting groove 62 which are adapted to the filter 50. The filter 50 is installed in the filter mounting groove 62, and the light passes through the filter 50 and the first light-through hole 61 and is incident on the photosensitive chip 30.

At the time of preparing the camera module 100, firstly the molded base 10 is molded on the circuit board 20, then the photosensitive chip 30 is bonded to the chip mounting surface 21, and then the separately molded filter seat 60 is bonded to the top surface of the molded base 10, and the filter 50 is installed in the filter mounting groove 62 of the filter seat 60.

The photosensitive chip 30 comprises a photosensitive area and a non-photosensitive area. The projection of the filter seat 60 in the Z direction at least covers part of the non-photosensitive area of the photosensitive chip 30, thereby reducing the size of the filter 50 and reducing the risk of the filter 50 breaking.

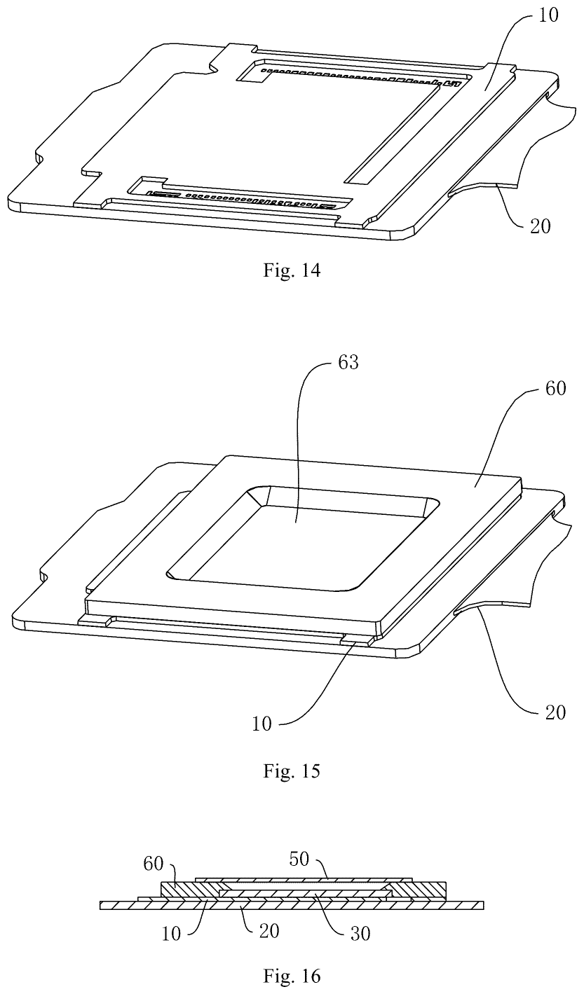

FIG. 14 is a schematic diagram showing a molded base being molded on a circuit board according to an exemplary example of the present application, FIG. 15 is a schematic diagram showing a filter seat being molded on a molded base according to an exemplary example of the present application, and FIG. 16 is a sectional view of the circuit board, the molded base and the filter seat. As shown in FIGS. 14-16, in some examples, after the molded base 10 is molded on the circuit board 20, the photosensitive chip 30 is bonded to the chip mounting surface 21. The photosensitive chip 30 is electrically connected to the circuit board 20 through lead wire. The filter seat 60 is then molded onto the top surface of the molded base 10. The filter seat 60 covers at least a part of the non-photosensitive area of the photosensitive chip 30. Firstly, the molded base 10 is molded on the circuit board 20, and then the filter seat 60 is molded on the molded base 10, so that the photosensitive chip 30 is covered by secondary molding.

The filter seat 60 is provided with a second light-through hole 63, and the filter 50 can be bonded to the top surface of the filter seat 60. The light passes through the filter 50 and the second light-through hole 63 and is incident on the photosensitive chip 30. Molding the filter seat 60 on the molded base 10 is also beneficial to reducing the size of the filter 50, thereby reducing the risk of the filter 50 breaking.

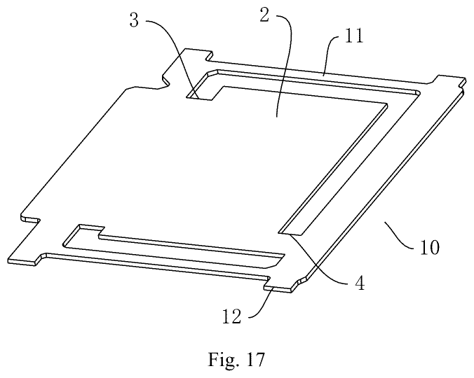

FIG. 17 is a schematic diagram showing a molded base according to an exemplary example of the present application. As shown in FIG. 17, in some examples, the top surface of the lug 12 is flush with the top surface of the mounting portion body 11, and the top surface of the second mounting portion 2 is flush with the top surface of the mounting portion body 11. The molded base 10 has a uniform thickness as a whole, which facilitates the molding of the molded base 10 and facilitates molding the filter seat 60 on the molded base 10. In other examples, the top surface of the lug 12 can also be higher than the top surface of the mounting portion body 11, and the top surface of the second mounting portion 2 is higher than the top surface of the mounting portion body 11.

As shown in FIG. 1, optionally, the camera module 100 further comprises a steel plate 70, and the steel plate 70 is arranged on a surface of the circuit board 20 away from the molded base 10, for example, the steel plate 70 is arranged on the bottom surface of the circuit board 20. The steel plate 70 is connected to the circuit board 20 by bonding. Mounting a steel plate 70 on the surface of the circuit board 20 away from the molded base 10 can reduce the possibility of warping of the circuit board 20, thereby improving the imaging quality of the camera module 100.

Optionally, a plurality of electronic components are arranged on the circuit board 20. When the molded base 10 is integrally molded on the circuit board 20, the molded base 10 covers at least a part of the electronic components on the circuit board 20 to provide protection for the covered electronic components.

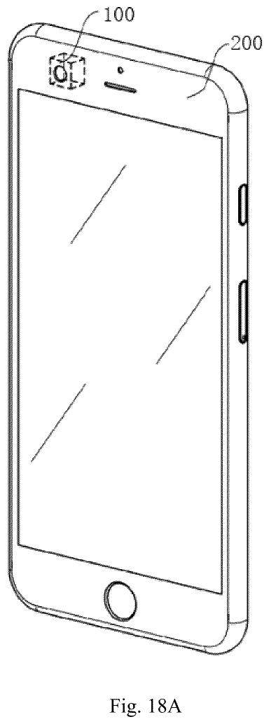

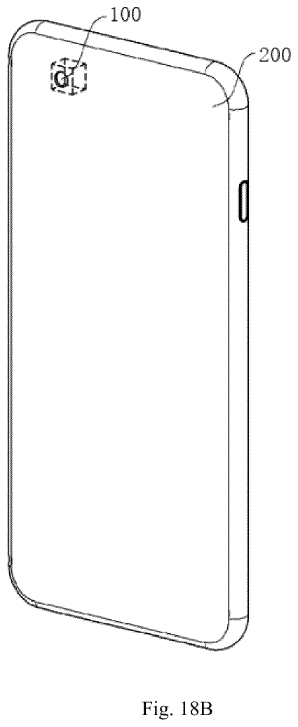

FIGS. 18A and 18B are schematic diagrams of electronic devices according to exemplary examples of the present application. As shown in FIGS. 18A and 18B, according to another aspect of the present application, an example of the present application provides an electronic device, wherein the electronic device comprises an electronic device body 200 and at least one camera module 100 as described above. Each camera module 100 is respectively arranged on the electronic device body 200 for acquiring images. It is worth mentioning that, the type of the electronic device body 200 is not limited. For example, the electronic device body 200 can be a smart phone, a tablet computer, a laptop computer, an e-book, a personal digital assistant, a camera, or any other electronic device that can be configured with a camera module 100. Those skilled in the art will appreciate that, although FIGS. 18A and 18B illustrate an example in which the electronic device body 200 is implemented as a smart phone, this does not constitute a limitation on the content and scope of the present application.

Exemplarily, as shown in FIG. 18A, the camera module 100 is arranged on the electronic device body 200 and faces the front side of the electronic device body 200, so that the camera module 100 serves as a front camera of the electronic device for photographing spatial objects in front of the electronic device body 200.

In addition, as shown in FIG. 18B, the camera module 100 is arranged on the electronic device body 200 and faces the rear side of the electronic device body 200, so that the camera module 100 serves as a rear camera of the electronic device for photographing spatial objects behind the electronic device body 200.

The examples of the present application are described in detail above. Particular examples are used herein to illustrate the principles and implementation modes of the present application. The description of the above examples is only used to help understand the technical solutions and core ideas of the present application. Therefore, any changes or modifications made by those skilled in the art based on the concept of this application, the particular implementation modes and the application scope of this application, shall fall within the protection scope of this application. In summary, the contents of this specification should not be understood as limiting the present application.

1. A molded base, wherein it comprises:
a first mounting portion having a lens mounting surface, wherein the first mounting portion comprises a first portion and a second portion;
a second mounting portion having a first side wall and a second side wall which are opposite to each other in the first direction, wherein the first portion of the first mounting portion and the first side wall of the second mounting portion are spaced in the first direction, and the second portion of the first mounting portion and the second side wall of the second mounting portion are spaced in the first direction, and the second mounting portion further has a chip mounting surface located between the first side wall and the second side wall;
a first connecting portion which is connected between the first portion of the first mounting portion and the first side wall of the second mounting portion; and
a second connecting portion which is connected between the second portion of the first mounting portion and the second side wall of the second mounting portion, and the sectional area of the first connecting portion being perpendicular to the first direction is larger than the sectional area of the second connecting portion being perpendicular to the first direction;
wherein when the molded base is prepared, a liquid injection port of a mold is arranged on a side close to the first connecting portion, and the liquid injection port of the mold and the second connecting portion are arranged substantially in a diagonal line, so that the molding liquid forms a flow path of the first connecting portion to the second mounting portion to the second connecting portion.

2. The molded base according to claim 1, wherein the first mounting portion comprises:
a mounting portion body having an inner side wall adjacent to the second mounting portion and an outer side wall away from the second mounting portion;
a lug arranged on the outer side wall of the mounting portion body, wherein the lens mounting surface is located on the lug.

3. The molded base according to claim 2, wherein the top surface of the lug is lower than the top surface of the mounting portion body.

4. The molded base according to claim 2, wherein the mounting portion body is in a frame shape surrounding the second mounting portion, and the mounting portion body has at least three corners, wherein at least three corners are provided with the lugs.

5. The molded base according to claim 1, wherein the chip mounting surface is substantially rectangular, and the first direction is a width direction of the chip mounting surface.

6. The molded base according to claim 1, wherein the sectional area of the first connecting portion is gradually decreased from the first mounting portion to the second mounting portion.

7. The molded base according to claim 1, wherein the first direction is parallel to the chip mounting surface, and a direction perpendicular to the first direction and parallel to the chip mounting surface is a second direction, and a direction orthogonal to the first direction and the second direction is a third direction, and in the second direction, the width of the first connecting portion is greater than the width of the second connecting portion, and/or in the third direction, the thickness of the first connecting portion is greater than the thickness of the second connecting portion.

8. A camera module, characterized by comprising:
a circuit board;
the molded base according to claim 1, which is arranged on the circuit board;
a photosensitive chip, which is arranged on the chip mounting surface of the second mounting portion;
a lens module, which is arranged on the lens mounting surface of the first mounting portion and is located in the photosensitive path of the photosensitive chip.

9. The camera module according to claim 8, wherein a groove is provided on the bottom surface of the lens module, and the lug of the first mounting portion is inserted into the groove.

10. The camera module according to claim 9, wherein a first gap is formed between the bottom of the groove and the lens mounting surface, and a second gap is formed between the wall of the groove and the lug, and the gap value of the first gap is smaller than the gap value of the second gap, and the first gap and the second gap are both filled with adhesive glue.

11. The camera module according to claim 10, wherein a third gap is formed between the bottom surface of the lens module and the circuit board, and the gap value of the third gap is greater than the gap value of the first gap, and the third gap is filled with adhesive glue.

12. The camera module according to claim 11, wherein the gap value of the third gap is smaller than the gap value of the second gap.

13. The camera module according to claim 8, wherein a filter mounting surface is provided on the top of the first mounting portion, and a filter is provided on the filter mounting surface, and the filter is located between the lens module and the photosensitive chip in the optical path.

14. The camera module according to claim 13, wherein a glue overflow groove is provided on the top of the first mounting portion, and the glue overflow groove is connected to the outer edge of the filter mounting surface.

15. The camera module according to claim 13, wherein a filter seat is provided on the top of the first mounting portion, and the filter is mounted on the filter seat.

16. The camera module according to claim 15, wherein the filter seat is molded on the molded base, and the filter seat covers a part of the photosensitive chip.

17. An electronic device, characterized by comprising:
an electronic device body;
the camera module according to claim 8, which is arranged on the electronic device body.
